(19) United States
(12) Patent Application Publication
(10) Pub. No.: US 2013/0248503 A1
(43) Pub. Date: Sep. 26, 2013

(54) METHOD FOR FORMING METAL MASK AND LASER DRILLING APPARATUS FOR FORMING THE SAME

(71) Applicant: Sung-Hsien LEE, Taichung City (TW)

(72) Inventor: Sung-Hsien LEE, Taichung City (TW)

(73) Assignee: SHUZ TUNG MACHINERY INDUSTRIAL CO., LTD.

(21) Appl. No.: 13/429,697

(22) Filed: Mar. 26, 2012

(51) Int. Cl. B23K 26/38; B23K 31/02; B23K 26/00

(52) U.S. Cl. 219/121.72; 219/121.67; 228/101

(57) ABSTRACT

The present invention is directed to a method for forming a metal mask. The method includes mounting a metal frame to a periphery of a supporting structure of a worktable, next placing a thin metal plate in a flat manner on a top surface constructed by the metal frame and the supporting structure, next forming a prototype mask by welding the thin metal plate with the metal frame, next forming multiple mesh holes in the thin metal plate by performing a laser drilling process to the prototype mask using a laser drilling apparatus.

### BACKGROUND OF THE DISCLOSURE

1. Field of the Disclosure

The invention relates to a method for forming a metal mask and a laser drilling apparatus for forming the same, and more particularly, to a yield-enhanced method for forming a metal mask and a laser drilling apparatus.

2. Brief Description of the Related Art

A traditional evaporation mask for an active-matrix organic light-emitting diode (AMOLED) is fabricated by first forming multiple micro mesh holes in a thin metal plate having a thickness of about 40 μm using a pattern etching process so as to form an evaporation mesh. Each of the mesh holes in the evaporating mesh has a size of just about 50 μm, and a pitch between neighboring ones of the mesh holes is just about 70 μm.

U.S. Pat. Pub. No. 2011/0183271 discloses another method for forming the evaporation mesh. The method is performed by first forming multiple slot holes in a thin metal plate and then trimming sidewalls of the slot holes with inclined surfaces using laser beams so as to form mesh holes in the evaporation mesh.

Referring to FIG. 10, an evaporation mesh 80, after completed, is placed on a metal frame 82. The evaporation mesh 80 has each side clipped by clips (not shown) and is stretched outwards to be flat. However, the evaporation mesh 80 and the mesh holes 801 therein have sizes of micrometer level, and thus it is difficult to stretch the evaporation mesh 80 to be flat without any deformation of the mesh holes 801 in the evaporation mesh 80.

In general, during stretching an evaporation mesh to be flat, the evaporation mesh requires being compared with a mother glass. If mesh holes in the evaporation mesh align with standard mesh holes in the mother glass, there is no deformation of the mesh holes in the evaporation mesh after stretched by the clips. Next, the evaporation mesh is welded with the metal frame and a total pitch is checked by a total-pitch measuring device so as to determine if the mesh holes in the evaporation mesh are positioned within allowable tolerances. The mesh holes in the evaporation mesh are required to pass double standard tests to see if a total pitch error is within ±5 μm and if a precision error compared with the standard mesh holes in the mother glass is within ±3 μm. If the comparison result does not pass the standard tests, there is deformation or shift of the mesh holes in the evaporation mesh when the evaporation mesh is stretched by the clips. At this time, stretching forces exerted by the clips requires being adjusted until the comparison result passes the standard test.

The above method for forming the evaporation mask has complicated steps and the mesh holes in the evaporation mesh are subject to deformation when the evaporation mesh is stretched by the clips. Thus, it is time consuming to adjust the stretching forces exerted by the clips. Besides, in the process of welding the evaporation mesh with the metal frame, it is possible that the mesh holes in the evaporation mesh deform or shift. Thus, checking the total pitch error should be performed after the welding process. Accordingly, the traditional method for forming the evaporation mask for an active-matrix organic light-emitting diode (AMOLED) is time inefficient and low yielding.

FIG. 11 is a schematic view illustrating a method for forming another evaporation mask for an active-matrix organic light-emitting diode (AMOLED) disclosed in Taiwan Pat. Pub. No. 200526794. A thin metal plate 91 is first placed on a mesh 920 at a center of a mesh frame 92, and the mesh 920 has the thin metal plate 91 kept with a flat surface. Next, multiple mesh holes 910 are formed in the thin metal plate 91 by laser cutting. Next, a fixing frame 93 is placed at a bottom of the thin metal plate 91 and the fixing frame 93 and the thin metal plate 91 are pressed together by a fixture set 94 and 95. Next, the fixing frame 93 and the thin metal plate 91 are welded together. Next, the fixing frame 93 and the thin metal plate 91 are cut from the mesh frame 92 such that the evaporation mask can be obtained.

### SUMMARY OF THE DISCLOSURE

The present invention is directed to a yield-enhanced method for forming a metal mask and a laser drilling apparatus.

The method includes performing a metal-frame feeding process to place a metal frame on a worktable having a supporting structure and to mount the metal frame to a periphery of the supporting structure, next performing a thin-metal-plate feeding process to place a thin metal plate in a flat manner on a top surface constructed by the metal frame and the supporting structure, next performing a welding process to weld the thin metal plate with the metal frame so as to form a prototype mask, and next performing a laser drilling process to form multiple mesh holes in the thin metal plate of the prototype mask using a laser drilling apparatus.

In one embodiment, the laser drilling apparatus includes a platform, a carrying mechanism movably mounted on the platform, a laser head mounted on the carrying mechanism, and a computer controlling movement of the carrying mechanism and the laser head and controlling the laser head to perform the laser drilling process.

In one embodiment, the laser drilling apparatus includes an inspection device mounted on the carrying mechanism.

In one embodiment, the method includes performing an inspection process and an adjustment process. During the laser drilling process performed by the laser head, the computer controls the inspection device to perform the inspection process and performs the adjustment process to the laser head such that the mesh holes in the thin metal plate, made by the laser drilling process, can meet standard.

In one embodiment, the method includes performing another inspection process by the inspection device. After the laser drilling process performed by the laser head, the computer controls the inspection device to perform the inspection process for inspecting if the mesh holes in the thin metal plate, made by the laser drilling process, meet standard.

Compared with prior art, in accordance with the present invention, the laser drilling process is performed after the thin metal plate is placed on the metal frame in a flat manner and welded with the metal frame. Accordingly, the deformation or shift of the mesh holes in the metal mask can be avoided and the metal mask has an improved yield.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

FIG. 1 is a flow chart of a method for forming a metal mask in accordance with the present invention.

FIG. 2 is a schematic view of a metal frame placed on a worktable in accordance with the present invention.

FIG. 3 is a schematic view of a thin metal plate placed on a metal frame and a supporting structure in a flat manner in accordance with the present invention.

FIG. 4 is a schematically front view of a laser drilling apparatus.

FIG. 5 is a schematically top view of a laser drilling apparatus.

FIG. 6 is a schematic view of a laser drilling process in accordance with the present invention.

FIG. 7 is a three dimensional view of a mesh hole in accordance with the present invention.

FIG. 8 is a cross sectional view along the line A-A in FIG. 7.

FIG. 9 is a cross sectional view along the line B-B in FIG. 7.

FIG. 10 is a schematic view of a traditional method for forming an evaporation mask for an active-matrix organic light-emitting diode (AMOLED).

FIG. 11 is another schematic view of another traditional method for forming an evaporation mask for an active-matrix organic light-emitting diode (AMOLED).

### DETAILED DESCRIPTION OF THE INVENTION

Illustrative embodiments accompanying with figures are now described below to lead the characteristics, contents, advantages and effects of the invention to be understood by the Examiner. Figures are illustrated only for explanation, but are not drawn to scale and precise arrangement, and thus the scope of the invention should not be limited by the scale and arrangement illustrated in the figures.

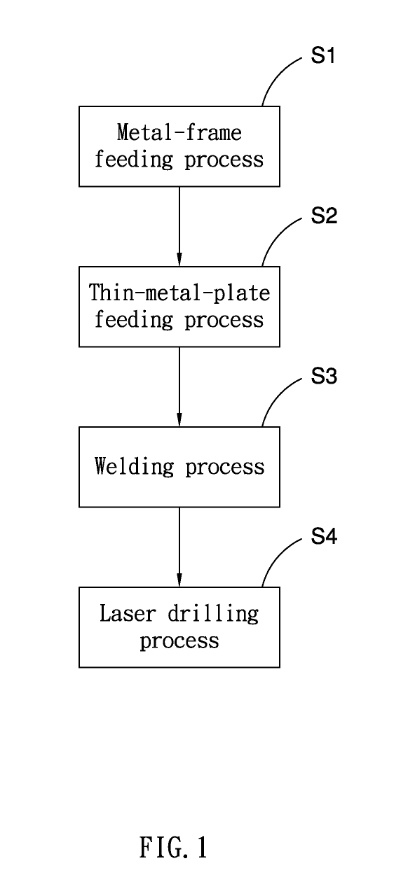

FIG. 1 is a flow chart of a method for forming a metal mask in accordance with the present invention. The method can be used to form, but not limited to, an evaporation mask, fine pitch metal mask (FMM), for an organic light-emitting diode. Alternatively, the method can be used to form a general metal mask, such as print mask used for a touch panel or in an IC packaging process. The method includes a metal-frame feeding process S1, a thin-metal-plate feeding process S2, a welding process S3 and a laser drilling process S4, wherein the metal-frame feeding process S1, thin-metal-plate feeding process S2 and welding process S3 are performed on a stretching machine.

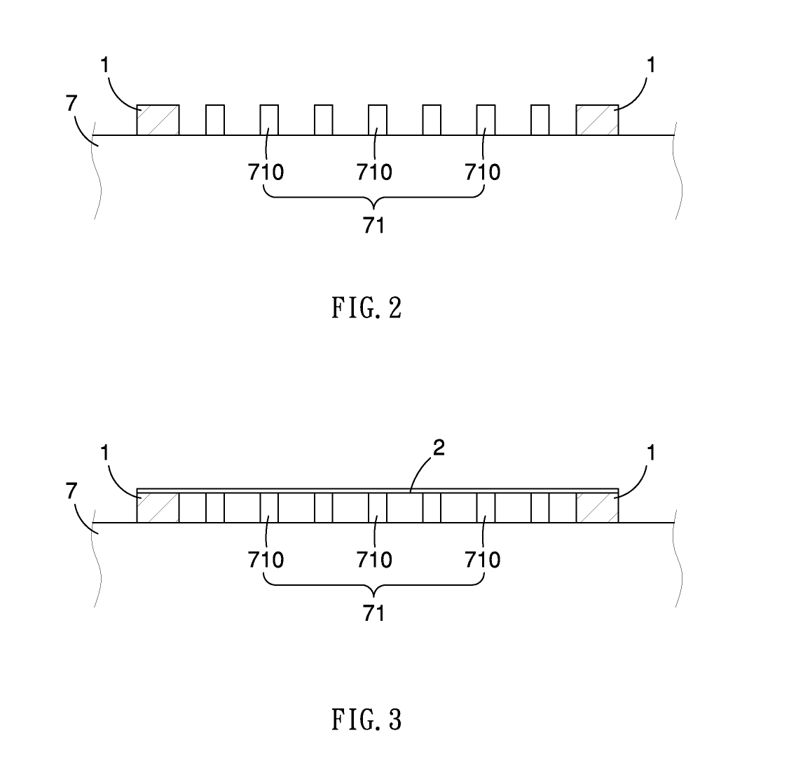

Referring to FIG. 2, the stretching machine includes a worktable 7, a supporting structure 71 on a top surface of the worktable 7 and a welding apparatus (not shown). The metal-frame feeding process S1 is performed to place a metal frame 1 on the worktable 7 and to mount the metal frame 1 to a periphery of the supporting structure 71. The supporting structure 71 includes, but not limited to, multiple supporting sticks 710. Referring to FIG. 3, the thin-metal-plate feeding process S2 is performed to place a thin metal plate 2 having a thickness of just about 40 μm on a top surface constructed by the metal frame 1 and the supporting structure 71. Alternatively, the thin-metal-plate feeding process S2 can be performed by stretching so as to make a top surface of the thin metal plate 2 become a plane. The welding process S3 is performed to weld the thin metal plate 2 with the metal frame 1 so as to form a prototype evaporation mask.

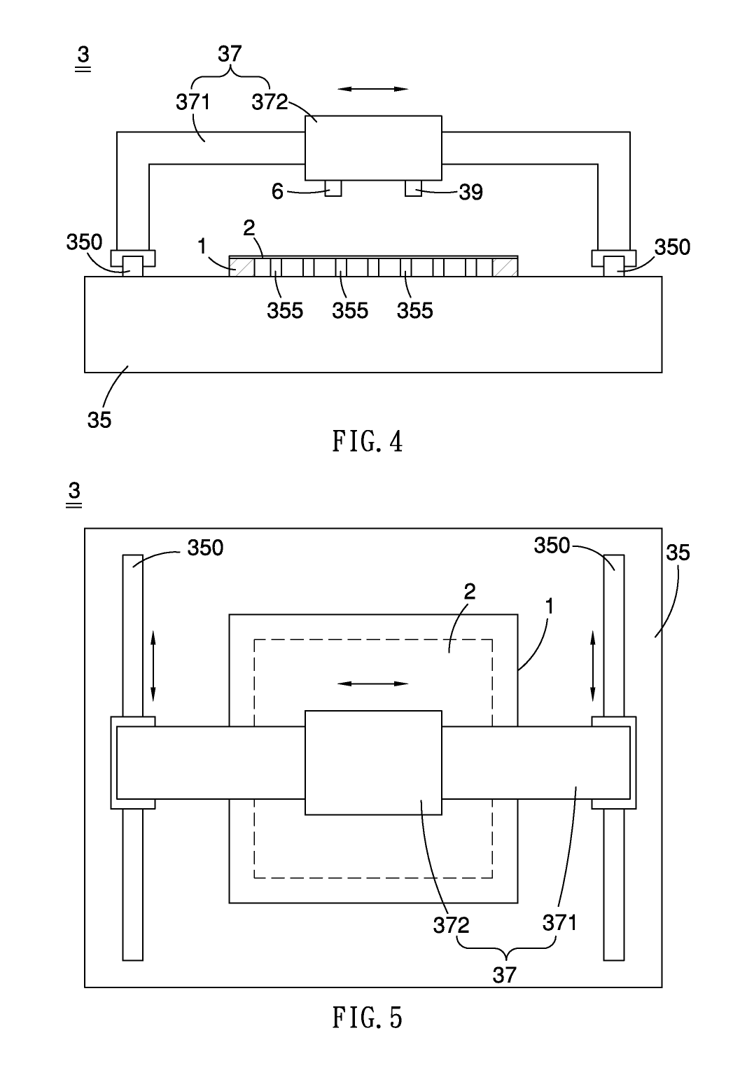

The laser drilling process S4 is performed to form multiple mesh holes in the thin metal plate 2 using a laser drilling apparatus 3 as shown in FIGS. 4 and 5. The laser drilling apparatus 3 includes a platform 35, a carrying mechanism 37, at least one laser head 39 and a computer (not shown).

The platform 35 is used to carry the thin metal plate 2 and the metal frame 1 which are welded together. The platform 35 includes a supporting structure having multiple supporting sticks 355 supporting the thin metal plate 2 such that the thin metal plate 2 has a top surface kept in a flat manner.

The carrying mechanism 37 includes a first moving part 371 and a second moving part 372. The first moving part 371 is mounted to a set of tracks 350 on the platform 35 and movable along the tracks 350. The second moving part 372 is mounted to the first moving part 371 and movable relatively to the first moving part 371.

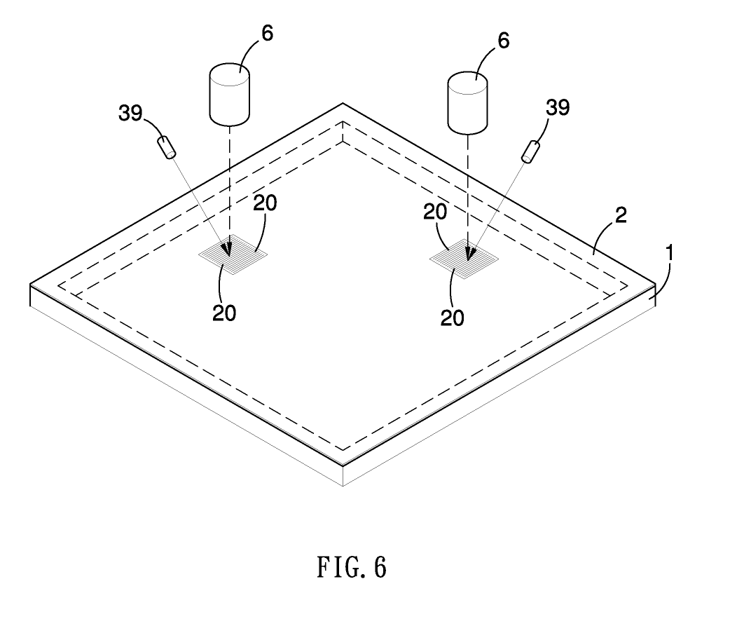

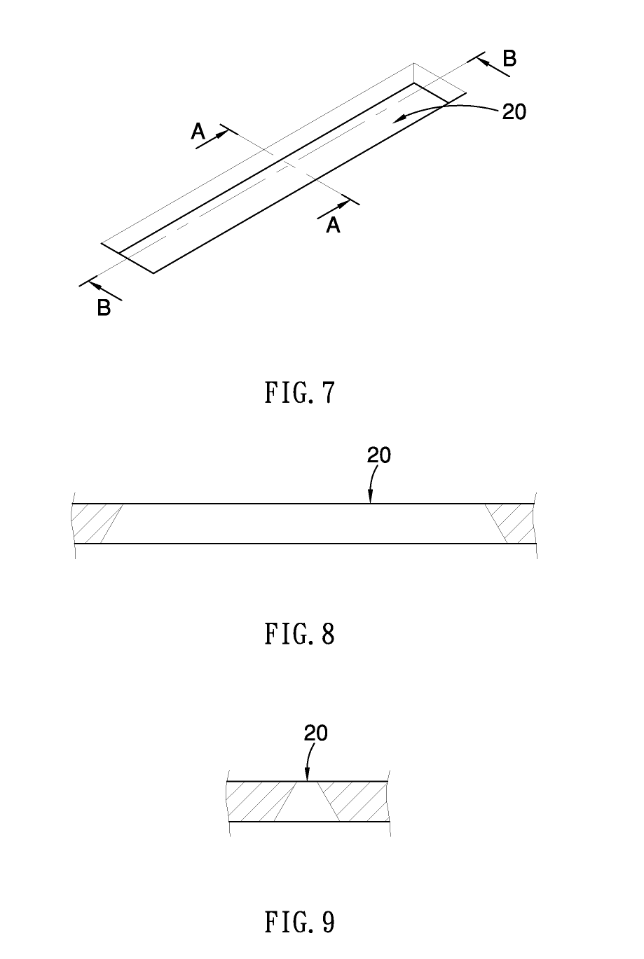

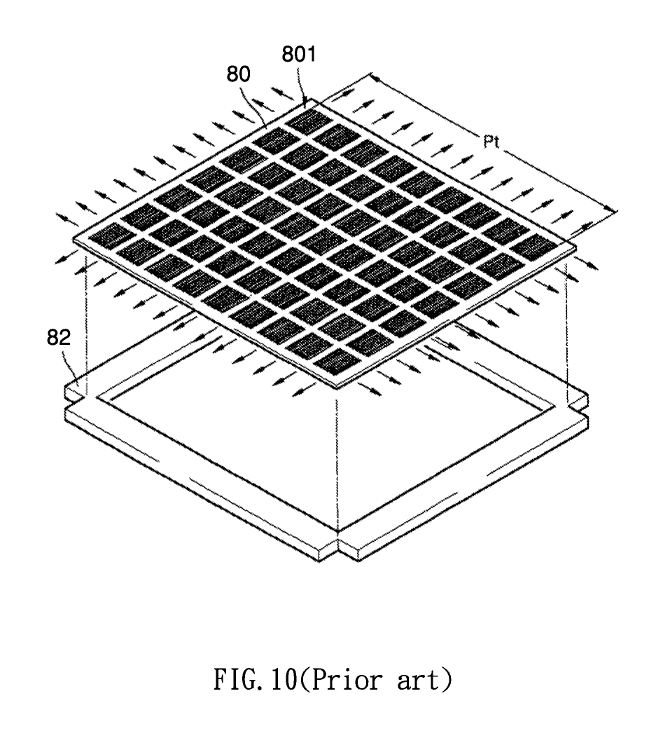

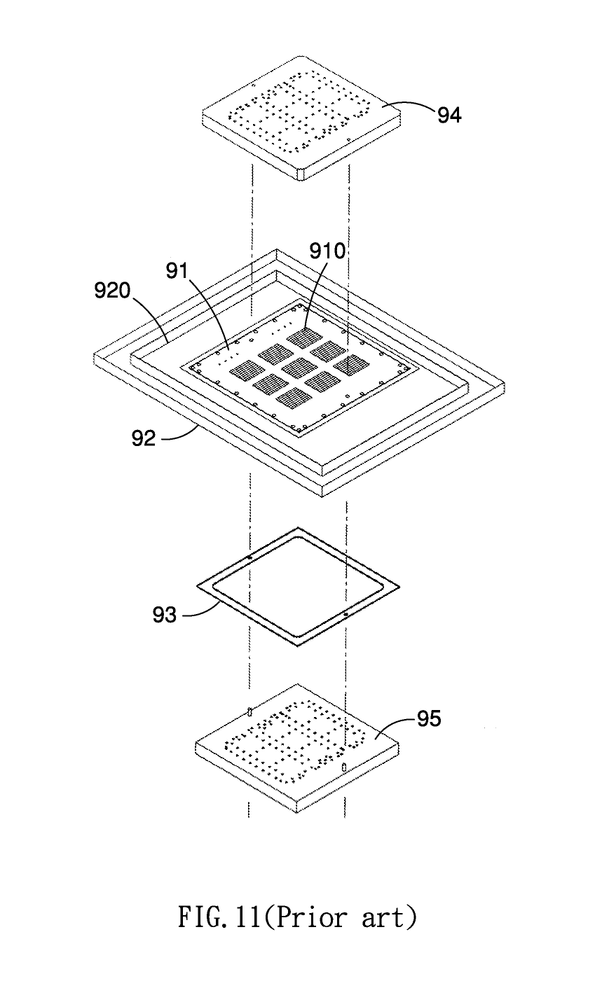

The laser head 39 is mounted on the second moving part 372 of the carrying mechanism 37 and used to drill holes in the thin metal plate 2 by laser. In one embodiment, the laser drilling apparatus 3 includes multiple laser heads 39 simultaneously controlled to drill holes in the thin metal plate 2 by laser during the laser drilling process S4, and thereby the speed of drilling holes can be enhanced. Alternatively, holes can be drilled in a vertical or inclined angle by the laser heads 39, as shown in FIG. 6 showing an example of drilling holes in an inclined angle by laser, such that each of the mesh holes 20 in the evaporation mask is tapered from bottom to top, as shown in FIGS. 7-9.

Referring to FIGS. 4 and 5, the computer is used to control movement of the carrying mechanism 37 and to control the laser head 39 to perform the laser drilling process S4 to the thin metal plate 2. The computer controls operation of the carrying mechanism 37 using an instrument (now shown) capable of precisely measuring a length such that the laser head 39 on the carrying mechanism 37 can precisely move to targeted positions for drilling holes.

In one embodiment, referring to FIGS. 4 and 5, the laser drilling apparatus 3 contains an inspection device 6 mounted on the second moving part 372 of the carrying mechanism 37, wherein the inspection device 6 is equipped with a CCD. In accordance with the present invention, the method includes performing an inspection process using the inspection device 6, wherein the inspection process may include the following two types:

In one type, when the laser drilling process S4 performed using the laser head 39, the computer of the laser drilling apparatus 3 controls the inspection device to perform the inspection process in real time and then based on the result from the inspection process, determines if an adjustment process to the laser head 39 is performed such that the mesh holes in the thin metal plate 2, made by the laser drilling process S4, can meet standard. For example, the mesh holes meet, but not limited to, a standard of a precision error within ±3 μm and a total pitch error within ±5 μm. Accordingly, the mesh holes formed in the evaporation mask can be ensured to meet standard using this way of inspecting the mesh holes in real time during the mesh holes are being formed.

In the other type, after the laser drilling process S4 performed by the laser head 39, the computer controls the inspection device 6 to perform another inspection process for inspecting if the mesh holes in the thin metal plate, made by the laser drilling process, meet standard. For example, the mesh holes 20 meet, but not limited to, a standard of a precision error within ±3 μm and a total pitch error within ±5 μm.

Compared with prior art, in accordance with the present invention, the laser drilling process is performed after the thin metal plate is placed on the metal frame in a flat manner and welded with the metal frame. Accordingly, the deformation or shift of the mesh holes in the metal mask can be avoided and it does not take too much time to adjust the stretching forces exerted by the clips. Thus, the metal mask has an improved yield.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A method for forming a prototype mask, comprising:
mounting a metal frame to a periphery of a supporting structure;
placing a thin metal plate in a flat manner on a top surface constructed by the metal frame and the supporting structure; and
welding the thin metal plate with the metal frame.

2. A method for forming a metal mask, comprising:
providing a prototype mask comprising a metal frame and a thin metal plate welded with the metal frame; and
performing a laser drilling process to form multiple mesh holes in the thin metal plate.

3. The method of claim 2 further comprising performing an inspection process and an adjustment process during said performing the laser drilling process such that the mesh holes made by the laser drilling process meet standard.

4. The method of claim 2, after said performing the laser drilling process, further comprising performing an inspection process for inspecting if the mesh holes made by the laser drilling process meet standard.

5. A laser drilling apparatus comprising:
a platform for carrying a prototype mask comprising a metal frame and a thin metal plate welded with the metal frame, wherein the platform comprises a supporting structure for supporting the thin metal plate of the prototype mask;
a carrying mechanism movably mounted on the platform;
a laser head for performing a laser drilling process to the thin metal plate, mounted on the carrying mechanism; and
a computer for controlling movement of the carrying mechanism and controlling the laser head to perform the laser drilling process to the thin metal plate.

6. The apparatus of claim 5 further comprising an inspection device mounted on the carrying mechanism.

7. The apparatus of claim 6, wherein during the laser drilling process performed by the laser head, the computer is provided for controlling the inspection device to perform an inspection process and performing an adjustment process to the laser head such that mesh holes in the thin metal plate, made by the laser drilling process, meet standard.

8. The apparatus of claim 6, wherein after the laser drilling process performed by the laser head, the computer is provided for controlling the inspection device to perform an inspection process for inspecting if mesh holes in the thin metal plate, made by the laser drilling process, meet standard.
